(19) United States
(12) Patent Application Publication
(10) Pub. No.: US 2009/0018895 A1
(43) Pub. Date: Jan. 15, 2009

(54) Technique for correlating purchasing behavior of a consumer to advertisements

(75) Inventors: Lee S. Weinblatt, Teaneck, NJ (US); Gerard Roccanova, Huntington Beach, CA (US)

Correspondence Address: COHEN PONTANI LIEBERMAN & PAVANE LLP, Suite 1210, 551 Fifth Avenue, New York, NY, 10176, US

(73) Assignee: Lee S. Weinblatt, Teaneck, NJ (US)

(21) Appl. No.: 12/075,651

(22) Filed: Mar. 12, 2008

Related U.S. Application Data
(60) Provisional application No. 60/906,482, filed on Mar. 12, 2007.

(51) Int. Cl. G06Q 10/00; H04N 5/225

(52) U.S. Cl. 705/10; 348/207.99; 348/E05.024

(57) ABSTRACT

A technique for correlating purchasing behavior of a consumer with advertisements to which the consumer has been exposed. The technique includes monitoring exposure of said consumer to advertisements to produce an advertisement monitoring signal, photographing an image related to an item purchased by the consumer to produce image data, processing the image data to derive consumer purchase data, and correlating the consumer purchase data with the advertisement monitoring signal.

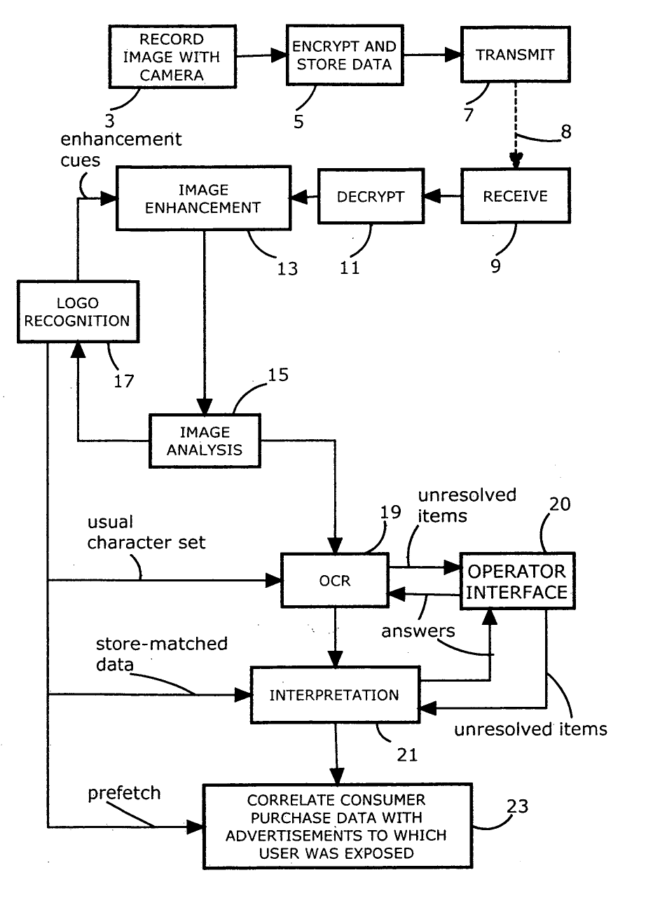

### RELATED APPLICATION

This application is based on and claims the priority of provisional application No. 60/906,482 filed Mar. 12, 2007.

### FIELD OF THE INVENTION

This invention is directed to a technique which monitors the advertisements to which consumers selected as test subjects are exposed as well as the subsequent purchases made by those consumers and, in particular, to an improved technique for collecting purchase data in order to correlate the purchases with the advertising.

### BACKGROUND OF THE INVENTION

Expenditures on advertising (e.g. television commercials, radio commercials, print advertising and Internet advertising) of consumer products in the U.S. typically exceed one hundred billion dollars per year. Advertisers who spend such huge sums of money understandably want to determine whether the money is being well spent and, if not, how improvements can be made.

Factors which affect the cost of an advertising and/or promotion campaign include (1) the extent of geographic coverage, (2) the advertising medium (e.g. print, radio, television), (3) how many advertising media are used, (4) frequency of use for the advertisement and/or promotion, (5) the time slot, and (6) the time duration of the campaign. When an advertising campaign is launched, these factors are decided upon based on various considerations of importance to a particular advertiser, which need not be delved into in detail for present purposes. However, with the initial decisions having been made, the advertiser must have feedback to assess whether the campaign is working. A change in total sales is not enough because that could be happening regardless of, or perhaps even in spite of, the campaign rather than because of it. What the advertiser must know is (a) was a targeted portion of the public exposed to the advertising campaign as planned, and (b) did the consumers who were exposed to the campaign purchase the product or services covered by it.

Various techniques are currently available to provide information of this nature. However, each of these suffers from various drawbacks. The first, and most primitive, involves an interview conducted by phone or, for example, at a shopping center. During such interview the consumer is asked to recall exposure to a particular advertisement and to disclose the subsequent purchases that were made. Results obtained with this technique are suspect because of the heavy reliance on memory, and a person's inclination to be biased, perhaps even subconsciously, in favor of what is of interest to the interviewer which then tends to color the consumer's responses to the interviewer's questions.

A second known approach involves recording the television programming, including commercials of course, watched in a particular household. Content from Internet access can also be recorded in a like manner along with advertisements that the Internet user is exposed to, such as banner ads, pop-up ads, etc. This information is stored in an electronic memory. Consumer purchase behavior is recorded by the use of a bar code reading apparatus, such as a wand, which is passed over each purchased product when it is brought home. Information available with this technique is of limited value because it is usable only with products bearing a bar code. A great number of products are not sold with a bar code, such as gasoline, pharmaceuticals, major appliances and unpackaged food items. Moreover, the purchase of services, such as is provided by airlines, movie houses and theatres, certainly cannot be monitored. Many products are also purchased away from home (e.g., lunch and snacks from a convenience store) and not brought home. Also, a great deal of effort by the consumer is required to scan each and every purchased item individually. Since the scanning must be done when the consumer returns home and before the purchases are stored away, the person is already tired and/or eager to get started on other tasks and, therefore, may not perform the scanning. Such failure to carry out the recording-of-purchases part of this monitoring approach is even more likely for perishable items such as ice cream which need to be refrigerated or kept frozen almost immediately upon the consumer's return home. Consequently, consumer cooperation with this technique is also suspect in addition to being of limited value due to total reliance on only bar-coded items.

A third technique involves a particular store that has been equipped with special computer equipment to identify certain consumers and to record their purchases. Identification of the consumer is accomplished with a card given to the consumer and on which a unique code has been recorded. When the consumer arrives at the cash register, the card is handed to the cashier who uses it to enter the code. As the purchases are “rung-up” on the cash register, they are also recorded as having been made by the consumer whose identity is established by the code on the card. This purchasing behavior is stored in the special computer, and the information is periodically downloaded to a computing center. That computing center also receives information on the television commercials and Internet advertisements to which the same consumer was exposed, and collected in the same way as described above for the second technique. However, this approach requires installation of relatively expensive computer equipment in a store, and only a very few stores can, therefore, be involved in the monitoring effort. Consequently, purchases made elsewhere by the consumer go unrecorded. As a result, the amount of information collected may provide less than a meaningful sample.

A fourth technique is to equip cash registers with a device to include machine-readable indicia on a sales receipt provided to consumers after the purchase of goods and/or services. The machine-readable indicia, such as a bar code, can then be read by a products/services code reader such as a bar code reader located in a consumer's home to identify the purchased goods/services. The bar code data can then be correlated with data representing the consumer's prior exposure to advertisements and used to gauge the effectiveness of such advertisements on the consumer's purchases. Such a technique is more-fully disclosed in U.S. Pat. No. 5,401,946. One drawback, however, is in the cost of equipping or “retro-fitting” cash registers with the hardware and software necessary to generate machine-readable indicia on the sales receipts. Another drawback is that retail store owners are reluctant to share consumer purchasing information with outside services or organizations. Therefore, these stores are averse to employing cash registers having such machine-readable indicia printing capability, especially if the data contained in the machine-readable indicia can be used by third parties.

The term “exposed” when it appears throughout this specification is used in the sense of locating the consumer who is a participant in the test in such close proximity to the advertisement that the probability of the advertisement having a mental impact is high. This requires that, for example, a radio advertisement monitoring system provide not only information about when the advertisement was broadcast or even that the consumer was in the same house as the radio set when the commercial was broadcast, but that the consumer was within a relatively small distance of the radio set at that time. The same relatively stringent requirements are applied to television commercial monitoring, Internet advertisement and print ad monitoring before it can be said that the consumer has been “exposed” to it.

### SUMMARY OF THE INVENTION

One object of the present invention is to increase the size of the data sample, at relatively low cost, for correlating purchasing behavior with exposure to advertising.

Another object of the present invention is to improve the reliability of such information.

A further object of the present invention is to maintain the security of purchasing information recorded by consumers.

Another object of the present invention is to provide meaningful results very soon after the purchasing data is recorded by the consumer.

Yet another object of the present invention is to facilitate the monitoring of purchasing behavior by avoiding the need to retrofit equipment at the point of sale.

These and other objects are attained in accordance with one aspect of the present invention directed to technique for correlating purchasing behavior of a consumer with advertisements to which the consumer has been exposed. The technique includes monitoring exposure of said consumer to advertisements to produce an advertisement monitoring signal, photographing an image related to an item purchased by the consumer to produce image data, processing the image data to derive consumer purchase data, and correlating the consumer purchase data with the advertisement monitoring signal.

### BRIEF DESCRIPTION OF THE DRAWING

The only drawing is a block diagram of an apparatus arranged in accordance with an embodiment of the invention for recording consumer purchase information and correlating it with advertising to which the consumer has been exposed.

### DETAILED DESCRIPTION OF THE DRAWING

Monitoring of the exposure to advertisements by consumers has been done for quite some time, and is well known. A number of techniques have been utilized for the print, radio television and Internet media. Any of those techniques can be used for the present invention. The following particular techniques for monitoring each of these types of media are mentioned by way of example.

It is desirable to monitor the exposure of a consumer who has been selected as a test subject under realistic rather than artificial conditions. Consequently, the testing environment is not that of a test laboratory but, rather, any location to which the consumer is likely to go during a regular day. This includes, of course, the home and other similarly common and normal sites for one's daily activities. Otherwise, it is felt that the test results may be skewed due to the artificial conditions to which the consumer would be subjected. It is also preferable to minimize contact of the consumer with testing personnel, and this is done by automating the monitoring process.

In order to automate monitoring of the consumer on his daily routine, it is necessary to provide him/her with an apparatus that can do the requisite monitoring while not restricting his/her movement or being so obtrusive as to somehow affect the testing. This is particularly so with respect to any apparatus which monitors exposure to radio advertisements and print ads which are likely to occur away from the house or office in contrast to television and Internet exposure which is most likely to occur in the house or office, e.g., place of work, etc. Thus, the system for monitoring the radio and print media is preferably portable and is such as to be conveniently worn on the person of the consumer. For television commercials and Internet advertisements, on the other hand, it is less important because an apparatus could effectively be used which is installed in the home or office.

An advertising monitoring system for measuring the exposure of a consumer test subject (referred to interchangeably herein as a “user”) to radio advertisements is disclosed in U.S. Pat. No. 4,718,106 issued Jan. 5, 1988 to the present inventor. That patent is hereby incorporated by reference. Briefly, this patent discloses an apparatus that can be incorporated into a wristwatch. It includes a microphone for picking up audible signals from a radio set. A particular survey code signal is periodically transmitted by the radio station and subsequently audibly reproduced by the radio set to be picked up by the microphone. The microphone outputs a resulting signal to a detection circuit which has been preset to produce an output signal only when the particular survey code signal is detected. Such an “event” is stored in an electronic memory together with the associated time. The microphone and its associated circuitry have a sensitivity set such that the survey code signal will be detected and processed only if the consumer is within a relatively short distance from the radio. Thus, it is possible to determine when (i.e. from the recorded time) the consumer was listening to that particular radio station (i.e. from the recordal of an “event” based on a signal transmitted only by that station). By combining this knowledge with the time during which a particular advertisement was being broadcast by the radio station, it is possible to determine that the consumer was “exposed” to it.

A television commercial monitoring apparatus can be implemented as disclosed in U.S. Pat. No. 4,695,879 issued Sep. 22, 1987 to the same inventor. That patent is hereby incorporated by reference. Briefly, it discloses an apparatus coupled to the television tuner which keeps a record of the channels being viewed throughout the day. A detector is worn by the viewer on the head and includes a receiver responsive to signals emitted from a transmitter installed near or on the television set. The receiver is directional so that it responds only when the head of the viewer is aimed substantially toward the television set. When the receiver detects a signal from the transmitter, it in turn emits its identification code to circuitry which records the event, and that can also be located on the television set. Thus, the event of having the viewer aiming his head at a television set at any particular time is combined with information on what channel is being viewed at the same time to provide an indication of exposure of the viewer to that particular channel. If it is known what advertisement was being broadcast at that particular time on that particular channel, it can be determined that the viewer was “exposed” to it by virtue of having his head aimed at the television set.

In addition to use of U.S. Pat. No. 4,695,879 to monitor television commercials to which the consumer has been exposed, U.S. Pat. No. 4,718,106 mentioned above can, of course, also be used for this purpose by adapting it to television use rather than radio. In particular, the consumer/viewer test subject can be provided with circuitry incorporated, for example into a wristwatch. That circuitry would include a detector responsive to a code signal transmitted by the television station, for example, and in response only thereto a signal source in the television set would be activated. The resulting emitted signal from the signal source is detected by circuitry in the wristwatch and recorded as an “event” along with the time at which it occurred and it indicates “exposure” because the consumer was within a short distance from the set when it was tuned at that time to the channel transmitting the code signal (and therefore advertisement) of interest. All that information would be stored in memory incorporated within the wristwatch.

A print ad monitoring apparatus can be implemented as disclosed in U.S. Pat. No. 4,659,314 issued Apr. 24, 1987 to the same inventor. This patent is hereby incorporated by reference. Briefly, the invention in this patent involves an insert “card” frequently found slipped into magazines. The insert card carries a switchable transmitter and a switch. When the magazine is opened, the transmitter will be automatically switched on to energize the transmitter. The resulting emitted signal is picked up by suitable circuitry as an “event” indicative of exposure of the consumer to the magazine and the ad of interest.

An Internet monitoring apparatus can be installed in a PC in a user's home or office to monitor the user's Internet traffic, i.e. the websites visited by the user or the “banner” or “pop-up” ads exposed to the user during Internet browsing. As an example, one suitable apparatus is disclosed in U.S. Pat. No. 6,366,298 issued Apr. 2, 2002 to Haitsuka et al. Still other Internet monitoring systems will be readily known to those having ordinary skill in the art.

Once the advertising monitoring information has been collected and stored, it is necessary to collect information on the purchasing behavior of consumers so that the exposure to advertising can be correlated with the purchasing behavior, as explained above. One way this may be accomplished is to retrofit receipt-generating devices, such as cash registers, with a device for printing machine-readable indicia on each receipt. Such a device can be implemented as disclosed in U.S. Pat. No. 5,401,946 issued May 28, 1995 to the same inventor. That patent is hereby incorporated by reference. The most common type of machine-readable indicia is a bar code, but other types exist, such as watermarks, hologram marks, etc. which are well-known to those of ordinary skill in the art. As discussed above, however, equipping all or at least a vast majority of cash registers with the capability and functionality to print machine-readable indicia on receipts is costly. Moreover, such an undertaking will, invariably, require the consent of the cash register manufacturers so that compatible technology can be used for the numerous makes and models of cash registers that will need to undergo such modification. In addition, retail store owners and other goods and/or service providers may be reluctant to allow their cash registers to be modified to allow third parties to derive customer purchase data.

Rather than, or as an enhancement to, a system which reads machine-readable indicia on purchase receipts or directly from product packaging for identifying goods or services purchased by consumers, a home scanner and processor can be employed for reading and deciphering alpha-numeric characters that already exist on conventional receipts generated by cash registers (and from printed receipts of Internet purchases of goods and services) to allow customers to identify items that have been purchased. Such alpha-numeric characters may also provide the purchase price and typically the time/date of purchase and the purchase location, e.g., the store name and address. Such a technique is disclosed in copending U.S. patent application Ser. No. 11/158,853. Although this technique is useful and has various advantages over other approaches, it is not necessarily the best way of collecting information on the purchasing behavior of consumers.

The drawing depicts details of an apparatus for producing a correlation of the consumer's purchases and the exposed-to advertisements. A key aspect is the use of a digital camera by the consumer in a manner explained in detail below. The camera can be made unique to a particular consumer by storing a consumer identification (“ID”) code in it for tagging the consumer purchase data that the camera records. The ID code is associated with demographic data about the consumer which is useful to the advertiser to know, such as location, sex, age, education, marital status, income level, etc. Also, if several household members are to use the same camera, each member will typically have his/her own ID code which needs to be selected before that person operates the camera. This can be easily implemented as part of the camera's start-up sequence.

The camera is preferably a compact, digital camera with relatively simple features so as to keep its cost low. Thus, the camera has a fixed range, close-up wide angle lens with auto-focus or a small aperture so it can sharply capture the image of the subject. Such a lens provides instantaneous focusing and is very inexpensive. The subject being photographed can be a receipt listing the products purchased in a store, a magazine or newspaper cover, a purchased product, or an item related to purchased services (such as a theater ticket or airline ticket). The camera's resolution can be 1.3M pixels, for example. A diffused, polarized, wide-angle flash can be used for providing evenly distributed light to illuminate the subject and eliminate glare. The flash also highlights text on a colored paper type of receipt which some stores utilize. The camera further includes a rechargeable battery, clock, and LEDs to signal power, ready to record, and so on. An enhanced version of the camera can include buttons or a scroll wheel to provide information on the subject about to be photographed, such as whether it is from a supermarket, airline or retail store in order to speed up matching of the image with the associated data.

The camera also includes a memory for storing software to control its operations, which are described in more detail below, and for storing image data. It also utilizes components for transmitting the captured image data to a computer, such as a PC. Such data transmission can be via USB cable or wirelessly via WiFi or Bluetooth. The camera can also be incorporated into a cellphone, in which the data transmission can be via the phone.

Turning now to the drawing, block 3 depicts use of the camera by the consumer test subject (or “user”) to record the image of the subject, as it is described above. So, for example, if the user has been shopping in a grocery store and purchased several items, the photographed subject will be the purchase receipt provided by the store. The image capture can be a snapshot, a sequence of snapshots, or it can be a video (such as for long receipts). Block 5 depicts encryption of this data so that the privacy of the purchase information is maintained secure. Understandably, users may have some sensitivity about such private information becoming public knowledge, such as if the camera is stolen or lost. Consequently, the recorded image information is stored in encrypted form. The encryption can be done by any well known encryption algorithm using, for example, the user's unique ID code as a key for encryption and decryption. Furthermore, the ID code does not directly identify the user but, rather it serves to associate the user's particular demographic data with the purchase information. Thus, nowhere is the user's identity associated directly in connection with the consumer purchase information, neither in the camera nor at the remote processing center.

The encrypted image data is then transmitted, as per block 7, to a remote data processing center. The user's ID code is transmitted along with the encrypted image data. Block 7 and broken line 8 represent such transmission which can take place via a PC into which the data is first stored, or it can be done directly from the camera, such as when it is incorporated into a cellphone. It can occur at preset intervals, or at preset times, upon receipt of a trigger signal from the processing center, or just at the user's actuation. Alternatively, all of the image data can be recorded on a magnetic disc, and that disc can then be sent to the remote processing center.

Further operations which are described below occur at the processing center. The encrypted image data is received at the processing center, per block 9, and then decrypted, per block 11. Image enhancement, per block 13, is used to improve the quality of the image for further processing, such as by sharpening the lines defining letters. The image enhancement can be achieved by training the software to recognize the different fonts, inks and receipt formats to improve accuracy and to speed up the processing.

Image analysis, per block 15, serves to separate the photographed image into component blocks, the aim being to detect any logos the image may contain. The logos of interest are letters and/or designs that identify the company and/or store which advertises, markets and/or sells the product.

The logo recognition, as per block 17, takes the component blocks derived by image analysis 15 and determines whether any contain a logo. For example, logo recognition 17 can utilize a library look-up capability because the advertisers of interest are known, so their logos can be obtained, stored and used in this processing. Block 17 is in a feedback path from image analysis block 15 to image enhancement block 13. Such feedback depicts an iterative process used to improve the quality of the image outputted from block 13 since block 17 can assist in identifying any unique qualities associated with fonts, inks, etc characteristic of individual stores. Logo recognition block 17 also provides an output to OCR (Optical Character Recognition) block 19, as explained below. The output of logo recognition block 17 can also be used to prefetch data that will be required to narrow the search parameters for that specific advertiser during the correlation performed by block 23, as explained below.

As is well known, OCR processing is used to recognize the alphanumeric characters that appear in a digitized image. OCR block 19 represents use of any such OCR software. The input it receives from log recognition block 17 can be, for example, a character set of the font usually used by a particular store, which aids the OCR function in reducing recognition errors. Then OCR block 19 proceeds to identify the individual line items on the receipt. However, the OCR block 19 may be unable to resolve one or more characters. To handle such a situation, the unresolved character is provided to operator interface block 20, which may include a keyboard (not shown), a display (not shown) and suitable processing capability, all of which are well known to a person with ordinary skill in the art, so that details thereof are not deemed necessary. The operator then responds with a suitable answer, which can be stored (by OCR block 19, for example) for future use to avoid the need for repeated human intervention as a type of “training” function.

Interpretation block 21 serves to resolve the recognized characters from the previous block into actual purchased items. Store-matched data is provided from logo recognition block 17 to interpretation block 21 which relates the specific way a store may identify purchased items on its receipts to the characters recognized by the OCR processing. For example, different stores may identify this particular product as Heinz Ketchup, or Hnz ktchp, or H kchp. When a store is identified based on the detected logo, the appropriate store-matched data for that particular store's shorthand significantly facilitates the identification of the purchased items from the OCR's output. Also, the interpretation block calculates the day, date, and prices. Any discounts or coupon deductions are also interpreted and presented to the correlation block. However, the interpretation block 21 may be unable to resolve one or more purchased items. To handle such a situation, the unresolved purchased item is provided to operator interface block 20. The operator then responds with a suitable answer, which can be stored (by interpretation block 21, for example) for future use to avoid the need for repeated human intervention, again as a type of “training” function.

Once the data on the consumer's purchases has been derived, per the description provided above, that data is then correlated with the advertisements to which the user has been exposed. The latter information is available from any of the various described above. The correlation, per block 23, can provide very valuable results and this can be presented in any one of many possible outputs that are a matter of design choice. Some factors that can be included in any such presentation include whether the consumer was exposed to an advertisement of the purchased product, how long was such exposure before the purchase was made, how many exposures occurred, the media used for such exposure, the location of the exposure, the time of day of the exposure, whether a coupon was used, and so on.

The present invention lends itself very well to aid advertisers in assessing the level of interaction between different forms of advertising. This can be used by the advertisers for determining the best combination of scheduling, relative spending in each of the advertising media, and the order of presentation as to which medium should be advertised in first, second, etc. More specifically, and in particular with regard to television and radio advertising, a determination is initially made in some manner which need not be discussed here that the advertisements will appear at certain intervals (i.e. scheduling) in a particular advertising medium. As a second stage, the advertisement will appear in another medium together with or replacing the first medium, and so on. The relative amount of money (known by the term “weight”) spent in each of these media will depend on the frequency of appearance of the advertisement, the time slot, etc. Once the campaign is run in this manner, the purchasing results will be monitored. With the purchasing results in, the advertising campaign particulars can be juggled by changing the scheduling, weight and/or the order of presentation. The purchasing results can then be compared with those obtained previously in order to ascertain whether a desirable or undesirable trend is occurring. Further refinements of the campaign can then be made.

Although a preferred embodiment of the present invention has been disclosed in detail above, it will be apparent that various modifications thereto can readily be made.

We claim:

1. A method for correlating purchasing behavior of a consumer with advertisements to which the consumer has been exposed, comprising the steps of:
monitoring exposure of said consumer to advertisements to produce an advertisement monitoring signal;
photographing an image related to an item purchased by the consumer to produce image data;
processing the image data to derive consumer purchase data; and
correlating the consumer purchase data with the advertisement monitoring signal.

2. The method of claim 1, wherein the processing step comprises:
storing the image data in a camera used for the photographing step;
transmitting the stored image data to a processing center; and
interpreting the received image data to derive the consumer purchase data.

3. The method of claim 2, wherein the image data is encrypted prior to being stored in the camera, and the received image data is decrypted at the processing center prior to the interpreting step.

4. The method of claim 3, wherein the processing step comprises image enhancement.

5. The method of claim 4, wherein the processing step comprises image analysis and logo recognition.

6. The method of claim 2, further comprising providing a consumer identification signal in the camera, and transmitting the image identification signal to the processing center with the stored image data.

7. Apparatus for correlating purchasing behavior of a consumer with advertisements to which the consumer has been exposed, comprising:
advertisement monitoring means for monitoring exposure of said consumer to advertisements to produce an advertisement monitoring signal;
means for photographing an image related to an item purchased by the consumer to produce image data;
means for processing the image data to derive consumer purchase data; and
means for correlating the consumer purchase data with the advertisement monitoring signal.

8. The apparatus of claim 7, wherein the photographing means is a digital camera.

9. The apparatus of claim 7, wherein the digital camera has a fixed range.

10. The apparatus of claim 7, wherein the digital camera has a close-up wide angle lens.

11. The apparatus of claim 7, wherein the digital camera has an auto-focus.

12. The apparatus of claim 7, wherein the digital camera has a fixed range.

13. The apparatus of claim 7, wherein the digital camera includes means for providing a consumer identification signal.

13. The apparatus of claim 7, wherein the digital camera includes means for transmitting the image data to a processing center.

14. The apparatus of claim 7, wherein the digital camera includes memory for storing the image data.
